(19) United States
(12) Patent Application Publication
(10) Pub. No.: US 2019/0170327 A1
(43) Pub. Date: Jun. 6, 2019

(54) OPTICAL ILLUMINATOR DEVICE

(71) Applicant: LUMUS LTD., Ness Ziona (IL)

(72) Inventors: Tsion Axel EISENFELD, Ashkelon (IL); Jonathan Gelberg, Modiin (IL); Alon Koren, Zichron Yakov (IL)

(21) Appl. No.: 15/990,639

(22) Filed: May 27, 2018

Related U.S. Application Data
(60) Provisional application No. 62/593,943, filed on Dec. 3, 2017.

(51) Int. Cl. F21V 13/12; G02B 5/02; F21V 5/00; F21V 7/04; F21V 7/28; F21V 9/14; F21V 5/04

(52) U.S. Cl. CPC F21V 13/12; G02B 5/0278; F21V 5/002; F21V 5/048; F21V 7/28; F21V 9/14; F21V 7/041

(57) ABSTRACT

An illuminator device includes a diffuser and a light collecting and concentrating element. The diffuser receives light rays from a light source as input and distributes light rays as output. The light collecting and concentrating element includes an input optical aperture formed on a base surface, an output optical aperture formed on an opposing surface to the base surface, and at least two sidewalls. The sidewalls extend substantially between the input and output optical apertures. The diffuser optically attaches to the base surface such that light rays from the diffuser output couple into the light collecting and concentrating element through the input optical aperture.

### TECHNICAL FIELD

The present invention relates to substrate-guided optical devices which include a plurality of reflecting surfaces carried by a common light-transmissive substrate.

### BACKGROUND OF THE INVENTION

Form factor as a critical enabler for new applications has emerged as a central driver for design innovation in near eye display technology. Conical or tapered optical elements are typically used for combining multiple wavelengths of light and/or homogenizing light uniformity across an exit aperture for input to optical waveguide devices or systems used in such near eye displays. In such implementations, in order to uniformly fill the exit aperture, the conical or tapered optical element must be relatively long in the direction of light propagation relative to the input and exit aperture size. Moreover, conventional conical or tapered optical elements require additional optical components, upstream from the input aperture and/or downstream from the exit aperture, to shape the light output from the exit aperture for use as input to a follow-on optical system, such as an optical waveguide.

### SUMMARY OF THE INVENTION

The present invention is directed to an optical illuminator device that includes a light collecting and concentrating optical element, a diffuser, and a light source. The light collecting and concentrating optical element has an input aperture formed on a base surface and the diffuser is attached to the base surface. The diffuser distributes light rays, received from the light source, into the light collecting and concentrating optical element, which outputs the light rays from an output aperture, resulting in an output optical beam having high spatial uniformity and narrow angular distribution. The combination of the geometries of the optical element, the diffuser, and the light source provides the optical illuminator device with several key advantages, including, high power efficiency to minimize thermal load, increased battery life, and ease of manufacturing.

According to the teachings of an embodiment of the present invention, there is provided an illuminator device. The illuminator device comprises: a diffuser for receiving light rays from a light source as input and distributing light rays as output; and a light collecting and concentrating element including an input optical aperture formed on a base surface, an output optical aperture formed on an opposing surface to the base surface, and at least two sidewall surfaces extending substantially between the input and output optical apertures, wherein the diffuser is optically attached to the base surface such that light rays from the diffuser output are coupled into the light collecting and concentrating element through the input optical aperture.

Optionally, the illuminator device further comprises: a light source for transmitting the light rays as input into the diffuser.

Optionally, each of the base surface and the light source has an associated width, and wherein the width of the light source is less than the width of the base surface.

Optionally, each of the light source and the diffuser has an associated width, and wherein the width of the light source is less than the width of the diffuser.

Optionally, each of the light source and the diffuser has an associated width, and wherein the width of the light source is less than the width of the diffuser.

Optionally, each of the light source and the diffuser has an associated width, and wherein the width of the light source is less than the width of the diffuser.

Optionally, the diffuser is optically attached to the base surface by optically cementing at least a portion of the diffuser to at least a portion of the base surface.

Optionally, the diffuser is optically attached to the base surface via direct attachment of at least a portion of the diffuser to at least a portion of the base surface.

Optionally, the light collecting and concentrating element is constructed from a material having a refractive index less than or equal to approximately 1.52.

Optionally, a proportion of the light rays coupled into the light collecting and concentrating element are trapped inside the light collecting and concentrating element by total internal reflection.

Optionally, the diffuser and the light collecting and concentrating element are arranged such that a proportion of the coupled-in light rays are reflected at least once by at least one of the sidewall surfaces before being coupled out of the light collecting and concentrating element through the output optical aperture.

Optionally, the light collecting and concentrating element includes a substantially hollow section defined in part by each of the inner sidewall surfaces, the base surface, and the opposing surface.

Optionally, the illuminator device further comprises a coating applied to at least a portion of at least one of the sidewall surfaces.

Optionally, the coating is a reflective coating.

Optionally, the coating has diffusive properties.

Optionally, the coating is a dielectric coating.

Optionally, the illuminator device further comprises at least one lens optically attached to the light collecting and concentrating element.

Optionally, the at least one lens is optically attached to the base surface.

Optionally, the at least one lens is optically attached to the opposing surface.

Optionally, the at least one lens is a negative lens.

Optionally, the illuminator device further comprises at least one polarizer optically attached to the light collecting and concentrating element.

Optionally, the sidewall surfaces are substantially planar surfaces.

Optionally, the sidewall surfaces are substantially curved surfaces.

There is also provided according to an embodiment of the teachings of the present invention an illuminator device. The illuminator device comprises: a light source for transmitting light rays, the light source including an output surface, having an associated width, from which the light rays are transmitted; and a light collecting and concentrating element including: an input optical aperture having a diffuser optically attached thereto, the input optical aperture formed on a base surface having an associated width that is greater than or equal to the width of the output surface, wherein the diffuser receives light rays from the light source and distributes light rays as input to the input optical aperture, an output aperture formed on an opposing surface to the base surface, and at least two tapered sidewall surfaces extending substantially between the input and output apertures.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a sectional view illustrating a schematic representation of an optical illuminator device, constructed and implemented according to an embodiment of the present invention, having a diffuser attached to a light collecting and concentrating optical element formed of multiple planar surfaces;

FIG. 2 is a sectional exploded view illustrating a schematic representation of the components of the optical illuminator device of FIG. 1;

FIG. 3 is a sectional view illustrating a schematic representation of an optical illuminator device, constructed and implemented according to an embodiment of the present invention, having a diffuser attached to a light collecting and concentrating optical element formed of multiple curved surfaces;

FIG. 4 is a sectional view of the light collecting and concentrating optical element of the device of FIG. 1, taken in a plane perpendicular to the optical axis, illustrating the rectangular symmetry of the light collecting and concentrating optical element;

FIG. 5 is a sectional view of the light collecting and concentrating optical element of the device of FIG. 1 or FIG. 3, taken in a plane perpendicular to the optical axis, illustrating the circular symmetry of the light collecting and concentrating optical element;

FIG. 6 is a sectional view illustrating a schematic representation of an optical illuminator device, similar to the device of FIG. 1, including a lens deployed at an output optical aperture of the light collecting and concentrating optical element; and

FIG. 7 is a sectional view illustrating a schematic representation of an optical illuminator device, similar to the device of FIG. 1, including a lens deployed between the diffuser and the light collecting and concentrating optical element.

### DESCRIPTION OF THE PREFERRED EMBODIMENTS

The present invention is directed to an optical illuminator device.

The principles and operation of the optical illuminator device according to present invention may be better understood with reference to the drawings accompanying the description.

The present invention is applicable to various imaging applications, such as, for example, cellular phones, compact displays, three-dimensional displays, and compact beam expanders, as well as non-imaging applications such as, for example, flat panel indicators, compact illuminators, and scanners. Embodiments of the present invention may be of particular value when applied to optical systems in the field of near eye display technology, in particular optical systems having a microdisplay that requires illumination from an illuminator in order to produce light that is coupled-into an aperture expanding optical waveguide.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways. Initially, throughout this document, references are made to directions such as, for example, front and rear, upper and lower, and the like. These directional references are exemplary only to illustrate the invention and embodiments thereof.

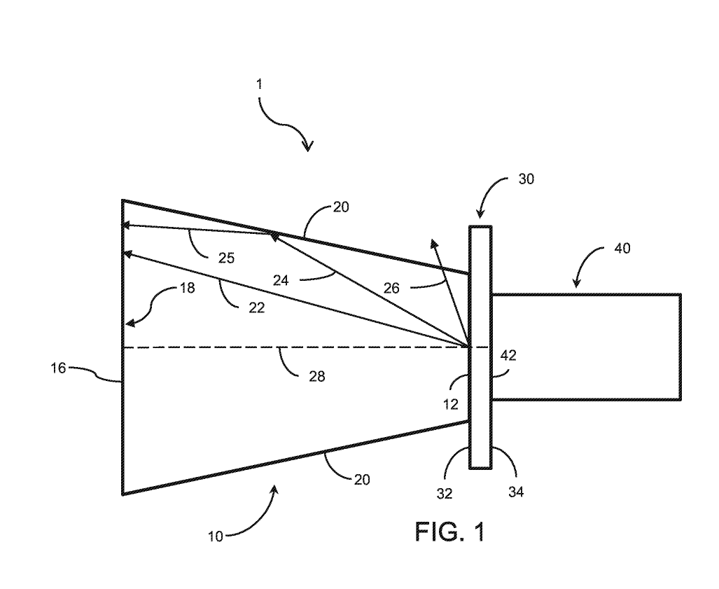

Referring now to the drawings, FIGS. 1-7 illustrate sectional views of an optical illuminator device, generally designated 1, and corresponding components of the optical illuminator device 1, constructed and implemented according to embodiments of the present disclosure. Generally speaking, the optical illuminator device 1 includes a light collecting and concentrating optical element 10 (referred to hereinafter as optical element 10), a diffuser 30, and a light source 40. The light source 40 transmits light (more generally radiation) into the optical element 10 via the diffuser 30. The light source 40 includes an output surface 42, at an end proximal to the diffuser 30, from which the light is transmitted.

The light source 40 can be implemented in various ways, and may be a polarized or unpolarized source. Examples of non-limiting implementations of the light source 40 include, but are not limited to, a light emitting diode (LED), a light pipe with RGB LEDs for color mixing, multiple LEDs that each emit a different color in combination with dichroic mirrors for color mixing, a diode laser, and multiple diode lasers that each emit a different color in combination with dichroic mirrors for color mixing.

The diffuser 30 receives transmitted light rays from the light source 40 as input and distributes (i.e., scatters), as output, the received light rays. The light rays distributed by the diffuser 30 is input to the optical element 10. In particular, the diffuser 30 distributes the light such that the light rays coupled into the optical element 10, via the diffuser 30, cover a wide range of angles relative to the optical axis 28 of the optical illuminator device 1. The light that is coupled into the optical element 10 via the diffuser 30 are represented in FIG. 1 by the optical light rays 22, 24, 26.

The optical element 10 includes a base surface 12 on which an input optical aperture 14 (referred to interchangeably as an entrance optical aperture) is formed, an output surface 16 oppositely disposed from the base surface 12 on which an output optical aperture 18 (referred to interchangeably as an exit optical aperture) is formed, and a plurality of inner sidewall surfaces 20 extending between the optical apertures 14 and 18 (i.e., between the surfaces 12 and 16). The output optical aperture 18 is typically at least three times larger than the input optical aperture 14, and the light rays from the light source 40 that propagate through the optical element 10 uniformly fill the output optical aperture 18. The base surface 12 is at a proximal end of the optical element 10 and the output surface 16 is at the distal end of the optical element 10. The terms “proximal” and “distal” are used in their normal senses to relate to the portions of the optical element 10 closer and further, respectively, from the diffuser 30.

The inner sidewall surfaces 20 extend between the surfaces 12 and 16 such that for each of the inner sidewall surfaces 20, a proximal end or edge of the inner sidewall surface 20 terminates at a portion of the base surface 12 and a distal end or edge of the inner sidewall surface 20 terminates at a portion of the output surface 16. As shown in the drawings, at least two of the inner sidewall surfaces 20 are generally oppositely disposed from each other.

Note that although the surfaces 12 and 16 are illustrated in FIGS. 1-3, 6 and 7 with solid black lines, it should be understood that the surfaces 12 and 16 are light transmitting surfaces which allow light rays to propagate through the optical element 10 (i.e., enter and exit the optical element 10) via the corresponding optical apertures 14 and 18 formed thereon.

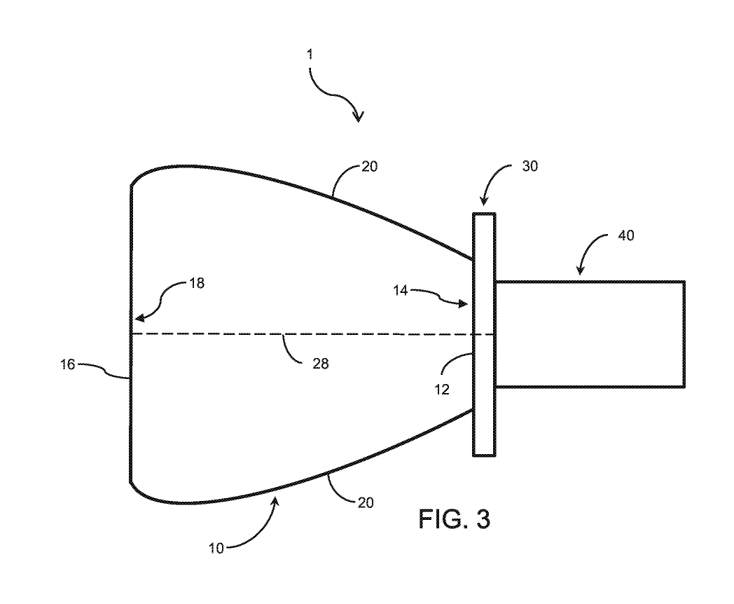

According to certain embodiments, the optical element 10 is constructed as a pyramid-like structure that has the general form of a pyramid with a removed top section, wherein the removed top section includes the pyramid apex. In such embodiments, the inner sidewall surfaces 20 are planar tapered sidewall surfaces which extend outward from the optical axis 28. In other embodiments, for example as is shown in FIG. 3, the inner sidewall surfaces 20 may be non-planar surfaces which have some degree of curvature, resulting in the optical element 10 having a conical-like structure.

In embodiments in which the optical element 10 is implemented as a pyramid-like structure, the optical element 10 may more specifically be formed as a square frustum, such that the base surface 12 and the output surface 16 are parallel planar square or rectangular surfaces. In other embodiments in which the optical element 10 is implemented as a pyramid-like structure, the base surface 12 is a concave or parabolic surface when taken in a cross-section along the optical axis 28. Note, however, that in certain embodiments, the base surface 12 and/or the output surface 16 may be rectangular or square planar surfaces, and one or more of the inner sidewall surfaces 20 may be non-planar surfaces which have some degree of curvature.

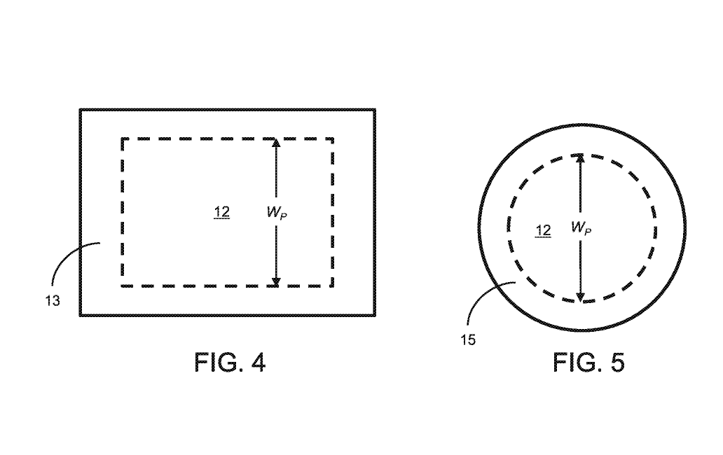

According to certain embodiments, the optical element 10 has rectangular symmetry about the optical axis 28. In such embodiments, the optical element 10 illustrated in FIG. 1 actually includes four planar tapered inner sidewall surfaces 20, as illustrated in FIG. 4, which shows a cross-section of the optical element 10 taken in a plane 13 parallel to the surfaces 12 and 16. In other embodiments, the optical element 10 has circular symmetry about the optical axis 28. Such circular symmetric configurations are applicable to the embodiments of the optical element 10 illustrated in FIGS. 1 and 3, and are illustrated in FIG. 5, which shows a cross-section of the optical element 10 taken in a plane 15 parallel to the surfaces 12 and 16. In FIGS. 4 and 5, the optical element 10 is viewed in the cross-sectional plane 13, 15 looking toward the diffuser 30, with the base surface 12 and shown in phantom.

The construction of the optical element 10 having rectangular or circular symmetry according to the above described embodiments enables filling of the output optical aperture 18 in three dimensions. Note, however, that in certain embodiments the optical element 10 may be constructed as a relatively flat, i.e., thin, optical element which enables aperture filling in two dimensions (i.e., in the plane of the paper). Such thin embodiments may be of particular value when used to illuminate a thin optical waveguide for back-lighting or front-lighting applications.

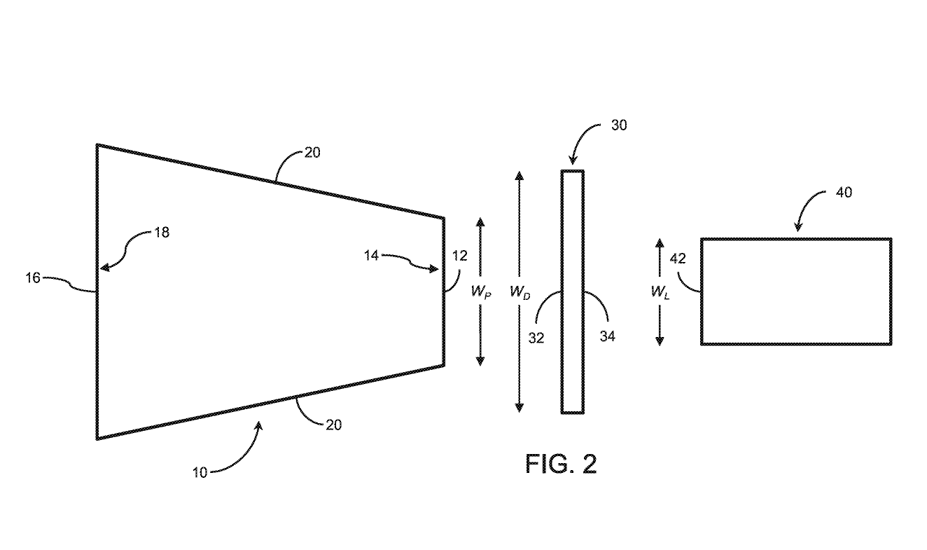

Each of the major components of the optical illuminator device 1 has an associated width, as illustrated in FIG. 2. Specifically, the base surface 12 has a width W_{P}, the diffuser 30 has a width W_{D}, and the output surface 42 has a width W_{L}. All of the widths are measured in a dimension perpendicular to the direction of propagation of a main light ray as it passes through the optical illuminator device 1. The optical element 10 further has a length of L_{P} that is measured from the base surface 12 to the output surface 16, in a dimension perpendicular to the width W_{P}.

According to certain embodiments, the width W_{L} is less than the width W_{P}. The two widths W_{L} and W_{P} may be equal, however, for ease of manufacturing, it is preferable that the width W_{L} be less than the width W_{P}, which allows for slight variations in the lateral placement of the light source 40 relative to the diffuser 30 and the optical element 10 without negatively effecting the performance and operation of the optical illuminator device 1.

The specific widths of the base surface 12, the diffuser 30, and the output surface 42 may depend on the specific materials used to construct the components of the optical illuminator device 1 and the specific types of components used. For example, depending on the type of diffuser 30 used to implement the optical illuminator device 1, a greater or lesser distance between the edges of the light source 40 and the edges of the base surface 12 may be required. Preferably, the width W_{D} is greater than both of the widths W_{P} and W_{L}, as shown in the specific implementation of the optical illuminator device 1 illustrated in FIGS. 1 and 2, for ease of construction of the optical illuminator device 1. However, the width W_{L} may be equal to the width W_{D}, and/or the width W_{P} may be equal to the width W_{D}.

The diffuser 30 is optically attached to the base surface 12 (i.e., the input optical aperture 14) of the optical element 10. By optically attaching the diffuser 30 to optical element 10 at the input optical aperture 14, the diffuser 30 and optical element 10 cooperatively function to homogenize the distribution of radiation (i.e., light), in terms of both power and chromatism, along the inner sidewall surfaces 20, which thereby enables larger W_{P} to L_{P} ratios (i.e., base to length ratios). The larger ratios allow significant reduction of the overall form factor of the optical illuminator device 1. The configuration of the optical element 10 together with the diffuser 30 enables the gathering of a large angular range of light rays, specifically the capture of particularly high angle lights rays emitted by the light source 40 into the input optical aperture 14, while at the same time achieving spatial uniformity of at least 85% at the output optical aperture 18.

The diffuser 30 includes a front surface 32 having at least a portion thereof optically attached to a portion of the base surface 12. The diffuser 30 may be optically attached to the base surface 12 in various ways. According to certain embodiments, the diffuser 30 may be directly engraved on the optical element 10 or the optical element 10 and the diffuser 30 may be carved or etched from a single slab of material (e.g., glass), such that the optical element 10 and the diffuser 30 are formed from a single body. In other embodiments, the diffuser 30 is a separate structure from the optical element 10 and is optically attached to the base surface 12 via an adhesive, such optical cement. In such embodiments, an air gap may or may not be present between the diffuser 30 and the optical element 10, however, it is preferred that no air gap be present in order to further reduce the overall form factor of the optical illuminator device 1.

In certain embodiments, the diffuser 30 and the light source 40 are optically attached to each other. The diffuser 30 further includes a rear surface 34, opposite from the front surface 32, having at least a portion thereof optically attached to a portion of the output surface 42. The optical attachment between the diffuser 30 and the light source 40 may be implemented in various ways, including, but not limited to, adhesively bonding together, via optical cement, the respective portions of the rear surface 34 and the output surface 42. Note that the area of the output surface 42 from which the light from the light source 40 is transmitted may be less than the area of the output surface 42 that is attached to the diffuser 30.

In general, the light rays from the diffuser 30 (in response to input form the light source 40) coupled into the optical element 10 can be classified into three groups, each represented by one of the three optical light rays 22, 24, 26. The first group of light rays, represented by the optical light ray 22, corresponds to the light rays propagating at a relatively small angle relative to the optical axis 28 (i.e., an angle less than approximately the absolute value of arctan(W_{O}/2L_{P}), where W_{O} is the width of the output surface 16) at the output of the diffuser 30. The optical light ray 22 propagates through the optical element 10 directly between the optical apertures 14 and 18 without any reflections from the inner sidewall surfaces 20.

The second group of light rays are light rays which undergo at least one reflection from at least one of the inner sidewall surfaces 20 before being coupled out of the optical element 10. The second group of light rays is represented by the optical light ray 24, which is coupled into the optical element 10 and reflected at least once before being coupled out from the optical element 10 via the output optical aperture 18. As shown in FIG. 1, the optical light ray 24 is reflected from the upper inner sidewall surface 20, and the reflected light ray 25 is then coupled out of the optical element 10 via the output optical aperture 18. As should be apparent, the light rays in the second group may be reflected by more than one of the inner sidewall surfaces 20. For example, in the non-limiting implementation in which the optical element 10 is constructed as a square or rectangular pyramid-like structure, a light ray from the diffuser 30 may reflect from one of the inner sidewall surfaces 20 and subsequently from a second inner sidewall surface adjacent to the surface of the first reflection, before being coupled out of the optical element 10 via the output optical aperture 18.

In certain embodiments, the optical element 10 is constructed from a material of relatively high refractive index, such that the light rays in the second group are subjected to total internal reflection (TIR) by the inner sidewall surfaces 20. In such embodiments, the light rays distributed by the diffuser 30 propagating at angles in a specific range of angles (relative to the optical axis 28) have corresponding angles of incidence (measured normal to the inner sidewall surfaces 20) that are greater than the critical angle defined by the refractive index, such that the light rays in the second group are subjected to TIR by the inner sidewall surfaces 20.

According to certain embodiments, the inner sidewall surfaces 20 may be coated with an angularly selective light reflective material instead of being constructed from a material having a refractive index that induces TIR. Such angularly selective coatings allow optical light rays in specific angular ranges to be reflected by the inner sidewall surfaces 20, and optical light rays outside of such angular ranges to be transmitted through the inner sidewall surfaces 20. Alternatively, the inner sidewall surfaces 20 may be coated with an angularly selective reflective material together with being constructed from a material having a refractive index that induces TIR. The coating may be applied to specific areas of the inner sidewall surfaces 20 or to the entirety of the inner sidewall surfaces 20. The light reflective coating may be metallic or dielectric coating, and in certain embodiments has varying diffusive properties, such as those of a diffusive reflector, which may be implemented using a coating such as, for example, 3M Light Enhancement Film 3635-100.

The third group of light rays, represented by the optical light ray 26, corresponds to the light rays propagating at relatively large angles, relative to the optical axis 28, at the output of the diffuser 30, which translates to angles which are not reflected by the inner sidewalls 20 (due to being less than the critical angle required to undergo TIR and/or outside of an angular range defined by angularly selective coatings). As such, light rays in the third group do not undergo any reflections from the inner sidewall surfaces 20 and are thus prevented from exiting the optical element 10 via the output optical aperture 18. As shown in FIG. 1, the optical light ray 26 is coupled into the optical element 10 at a relatively high angle and impinges on one of the inner sidewall surfaces 20 (e.g., the upper sidewall surface in FIG. 1) where it exits the optical element 10 via transmission through the upper sidewall surface without being re-directed, via reflection, to the output optical aperture 18. In general, only approximately 4%-7% of the light that is coupled into the optical element 10 via the diffuser 30 is lost due to coupling out through the inner sidewall surfaces 20. In other words, approximately 93%-96% of the light rays coupled into the optical element 10 via the diffuser 30 fall into the first or second group of light rays. Therefore, the vast majority of the light rays coupled into the optical element 10 via the diffuser 30 are thereafter coupled out of the optical element 10 through the output optical aperture 18.

In certain embodiments, the optical element 10 is constructed from a material of relatively low refractive index, for example, in a range between 1.33 and 1.5168. A low index of refraction effectively increases the critical angle such that none of the light rays output by the diffuser 30 are subjected to TIR upon being coupled into the optical element 10. In such embodiments, the entirety or portions of the inner sidewall surface 20 are preferably coated with angularly selective reflective material to effect reflection of the coupled-in light rays from the inner sidewall surfaces 20. Note that a relatively low index of refraction allows incoming optical light rays to expand more rapidly into the optical element 10 than would otherwise be permitted when using materials of higher refractive index. This enables the output optical aperture 18 to be uniformly filled using a shorter length L_{P}, when compared with conventional collecting and concentrating optics, such as, compound parabolic concentrators.

As should be understood by one of ordinary skill in the art, the optical light rays 22, 24, 26, as shown in FIG. 1, are an abstraction of light waves and a representation of light rays coupled into the optical element 10 from the diffuser 30. The optical light rays 22, 24, 26 are merely three of a multitude of similar such rays that cover a wide range of angles relative to the optical axis 28 and have corresponding trajectory paths through the optical element 10 (some of which include reflections from one or more of the inner sidewall surfaces 20) to uniformly fill the output optical aperture 18.

The optical element 10 may be constructed from various types of materials commonly used in optical illumination devices and systems. According to certain embodiments, such materials may include, but are not limited to, plastic and glass, which enables further reduction of the refractive index of the optical element 10. In certain embodiments, the surfaces 12, 16, 20 may define a hollow section in air or vacuum, to further reduce the refractive index to 1 (or nearly 1). In such embodiments, the optical element 10 may be constructed as a hollowed-out portion of plastic or glass, in which an interior section of a block or slab of material (e.g., glass) is carved or cut out until a hollowed-out cavity (e.g., a pyramid-like structure) forming the optical element 10 remains. Subsequent to the carving or cutting, the internal surfaces of the optical element 10 which form the inner sidewall surfaces 20 may be coated with a reflective coating (e.g., an angularly selective reflective coating) or a diffusive coating.

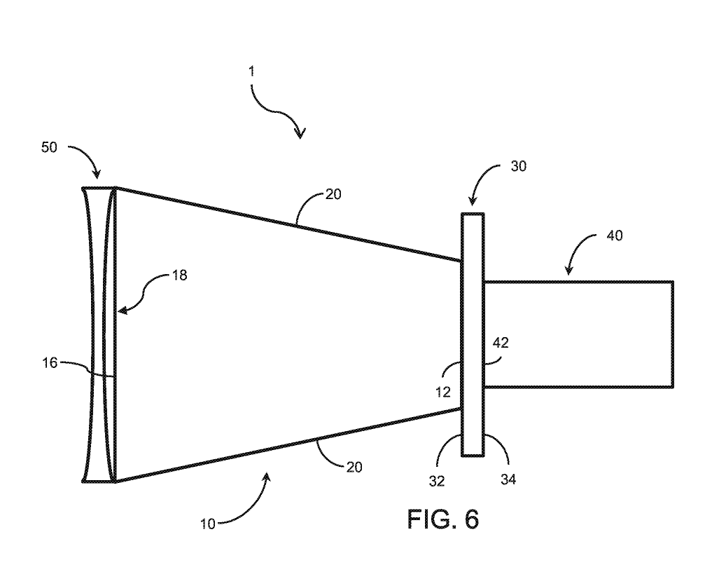

In addition to the major components of the optical illuminator device 1, additional components (e.g., optical elements and devices), including, but not limited to, one or more lenses, diffusers, polarizers, and a prismatic foil (e.g., 3M uniformity tape) may be optically attached to the optical element 10 at the base surface 12 and/or the output surface 16. The use of such lenses and prismatic foil further improves the light uniformity across the output optical aperture 18. FIG. 6 illustrates a particular embodiment of the optical illuminator device 1 that includes an additional component implemented as a lens 50 that is optically attached to the optical element 10 at the output optical aperture 18 via attachment to the output surface 16. Although in the embodiment illustrated in FIG. 6, the lens 50 is a negative lens (i.e., a concave lens), the lens 50 may be alternatively implemented as convex lens or series of lenses. In certain implementations, the lens 50 may not necessarily cover the entire output optical aperture 18 surface area, as illustrated in FIG. 6, but may in fact cover only a portion of said surface area.

In certain embodiments, a reflective polarizer, such as, for example, 3M Dual Brightness Enhancement Film (DBEF), is placed at the output optical aperture 18, for example, through attachment to the output surface 16 via optical cement. The placement of a reflective polarizer at the output optical aperture 18 induces polarization recycling, which may be of particular value in situations where the light source 40 is a non-polarized source but polarized light at the output of the optical illuminator device 1 is desired. The placement of a reflective polarizer at the output optical aperture 18 may also increase the brightness of the light that is coupled out of the optical element 10.

Furthermore, and as mentioned above, the optical illuminator device 1 may be of particular value when used to provide illumination to a microdisplay. In implementations in which the microdisplay is a backlit display relying on transmissive properties (e.g., LED-backlit displays), the microdisplay may be optically attached to the optical element 10 at the output surface 16 in order to receive illumination from the output optical aperture 18. In implementations in which the microdisplay is implemented as a reflective display (e.g., a liquid crystal on silicon), an intermediate optical arrangement, for example, a polarization beamsplitter prism, may be optically attached to the optical element 10 between the output surface 16 and the microdisplay in order to feed polarized light rays from the output optical aperture 18 to the reflective surface of the microdisplay.

The aforementioned additional components may be engraved or adhesively attached (e.g., via optical cement) to the base surface 12 and/or the output surface 16. In embodiments in which such additional components are adhesively attached to the optical element 10, it is preferred that such attachment is implemented without an air gap so as to limit the overall form factor of the optical illuminator device 1.

In embodiments in which an additional component is optically attached to the optical element 10 at the base surface 12, the diffuser 30 is attached to the optical element 10 via the additional component. In particular, portions of the front surface 32 of the diffuser 30 may be attached to portions at the front of the additional component (i.e., portions proximal to the diffuser 30) and portions of the base surface 12 are attached to portions at the rear of the additional component (i.e., portions proximal to the optical element 10). As such, the input aperture of the additional component (e.g., input aperture of a lens) functions as the overall input aperture of an optical unit resultant from the combination of the additional component and the optical element 10, and the front surface of the additional component functions as the overall base surface of the optical unit on which the input aperture is formed.

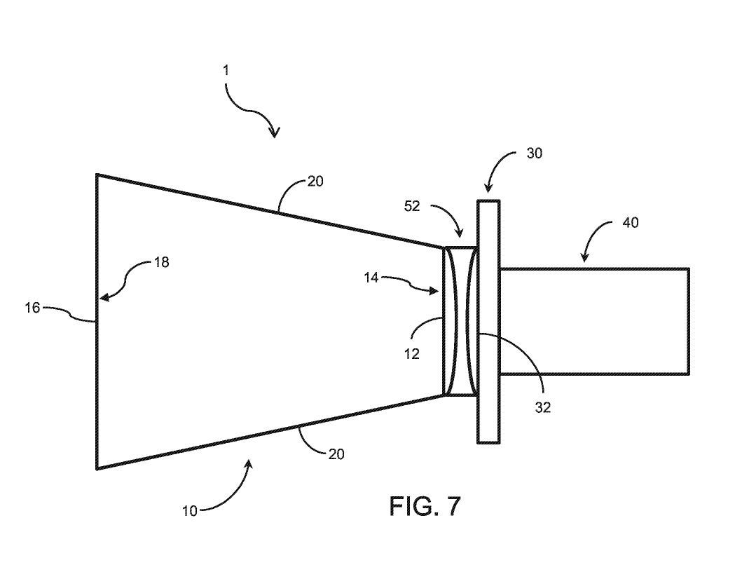

FIG. 7 illustrates a particular embodiment of the optical illuminator device 1 that includes an additional component implemented as a lens 52. In the embodiment illustrated in FIG. 7, the lens 52 is a negative lens (i.e., a concave lens) that is optically attached to the optical element 10 at the input optical aperture 14 via attachment to the base surface 12. The inclusion of such a negative lens at the input optical aperture 14 may further improve the light uniformity across the output optical aperture 18. The diffuser 30 is coupled to the optical element 10 via the lens 52. In particular, portions of the front surface 32 of the diffuser 30 are attached to portions at the front of the lens 52 (i.e., portions proximal to the diffuser 30) and portions of the base surface 12 are attached to portions at the rear of the lens 52 (i.e., portions proximal to the optical element 10). Accordingly, the input aperture of the lens 52 functions as the overall input aperture of the optical unit resultant from the combination of the lens 52 and the optical element 10, and the front concave surface of the lens 52 functions as the overall base surface of the optical unit on which the input aperture is formed.

As used herein, the singular form, “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. An illuminator device, comprising:
a diffuser for receiving light rays from a light source as input and distributing light rays as output; and
a light collecting and concentrating element including an input optical aperture formed on a base surface, an output optical aperture formed on an opposing surface to the base surface, and at least two planar tapered sidewall surfaces extending substantially between the input and output optical apertures, wherein the diffuser is optically attached to the base surface such that light rays from the diffuser output are coupled into the light collecting and concentrating element through the input optical aperture at a range of angles, and wherein a subset of the coupled-in light rays, corresponding to a sub-range of the range of angles, are trapped between the planar tapered sidewall surfaces by total internal reflection, so as to produce a spatially uniform output optical beam with narrow angular distribution at the output optical aperture.

2. The illuminator device of claim 1, further comprising:
the light source for transmitting the light rays as input into the diffuser.

3. The illuminator device of claim 2, wherein each of the base surface and the light source has an associated width, and wherein the width of the light source is less than the width of the base surface.

4. The illuminator device of claim 2, wherein each of the light source and the diffuser has an associated width, and wherein the width of the light source is less than the width of the diffuser.

5. The illuminator device of claim 1, wherein each of the base surface and the diffuser has an associated width, and wherein the width of the base surface is less than the width of the diffuser.

6. The illuminator device of claim 1, wherein the diffuser and the light collecting and concentrating element are formed from a single body.

7. The illuminator device of claim 1, wherein the diffuser is optically attached to the base surface by optically cementing at least a portion of the diffuser to at least a portion of the base surface.

8. The illuminator device of claim 1, wherein the diffuser is optically attached to the base surface via direct attachment of at least a portion of the diffuser to at least a portion of the base surface.

9. The illuminator device of claim 1, wherein the light collecting and concentrating element is constructed from a material having a refractive index less than or equal to approximately 1.52.

10-11. (canceled)

12. The illuminator device of claim 1, wherein the light collecting and concentrating element is formed from a hollowed-out portion of plastic or glass.

13. The illuminator device of claim 1, further comprising a coating applied to at least a portion of at least one of the sidewall surfaces.

14. The illuminator device of claim 13, wherein the coating is a reflective coating.

15. The illuminator device of claim 13, wherein the coating has diffusive properties.

16. The illuminator device of claim 13, wherein the coating is a dielectric coating.

17. The illuminator device of claim 1, further comprising at least one lens optically attached to the light collecting and concentrating element.

18. The illuminator device of claim 17, wherein the at least one lens is optically attached to the base surface.

19. The illuminator device of claim 1, wherein the at least one lens is optically attached to the opposing surface.

20. The illuminator device of claim 17, wherein the at least one lens is a negative lens.

21. The illuminator device of claim 1, further comprising at least one polarizer optically attached to the light collecting and concentrating element.

22-23. (canceled)

24. An illuminator device, comprising:
a light source for transmitting light rays, the light source including an output surface, having an associated width, from which the light rays are transmitted; and
a light collecting and concentrating element including:
an input optical aperture having a diffuser optically attached thereto, the input optical aperture formed on a base surface having an associated width that is greater than or equal to the width of the output surface,
an output aperture formed on an opposing surface to the base surface, and
at least two tapered sidewall surfaces extending substantially between the input and output apertures,
wherein the diffuser receives light rays from the light source and distributes light rays as input to the input optical aperture at a range of angles, and wherein a subset of the light rays input to the input optical aperture, corresponding to a sub-range of the range of angles, are trapped between the planar tapered sidewall surfaces by total internal reflection, so as to produce a spatially uniform output optical beam with narrow angular distribution at the output optical aperture.

25. The illuminator device of claim 1, wherein the diffuser includes a front surface, and wherein the illuminator device further comprises:
a negative lens having a first surface and a second surface, wherein at least a portion of the first surface is optically attached to the base surface, and wherein the diffuser is optically attached to the base surface via optical attachment of the front surface to at least a portion of the second surface.
